(19) United States
(12) Patent Application Publication
(10) Pub. No.: US 2018/0121538 A1
(43) Pub. Date: May 3, 2018

(54) Condensed Representation of Unique Identifiers on a User interface

(71) Applicant: SAP SE, Walldorf (DE)

(72) Inventors: Marvin Peter Follmann, Neckarsulm (DE); Ralf Stauffer, Schwegenheim (DE); Arndt Effern, Sinsheim-Dühren (DE); Guenter Briam, Wiesloch (DE)

(21) Appl. No.: 15/488,907

(22) Filed: Apr. 17, 2017

Related U.S. Application Data
(60) Provisional application No. 62/415,765, filed on Nov. 1, 2016.

(51) Int. Cl. G06F 17/30

(52) U.S. Cl. CPC G06F 17/30696; G06F 17/30663; G06F 17/30675

(57) ABSTRACT

Disclosed herein are system, method, and computer program product embodiments for a system for condensed representation of unique identifiers. An embodiment operates by determining a data set that includes a plurality of records. The records may be associated with a plurality of fields, each of which may be associated with a weight. One or more distinguishing field sets are determined that distinguish the plurality of records of the data set from each other. One of the distinguishing field sets is selected based on the weight. Data corresponding to the one or more fields, of the selected distinguishing field set, for the plurality of records is displayed on a display device.

### CROSS REFERENCE TO RELATED APPLICATIONS

This application claims priority to co-pending U.S. Provisional Patent Application No. 62/415,765, by Follmann, et al., “Condensed Representation of Unique Identifiers On A User Interface,” filed Nov. 15, 2016 which is hereby incorporated by reference in its entirety.

### BACKGROUND

The screen space that is available for displaying and navigating data on a user interface (UI) is often limited, particularly on mobile devices (e.g., which have smaller screen sizes). As such, how the user interface displays the data becomes increasingly important as the screen size (and correspondingly available space to display and navigate data) decreases. For example, too much data could result in either difficult to read text and/or an undesirable amount of user scrolling to be able to read/access all the data. Conversely, too little data may result in a data display that is no longer meaningful to the user.

### BRIEF DESCRIPTION OF THE DRAWINGS

The accompanying drawings are incorporated herein and form a part of the specification.

FIG. 1 is a diagram of an example data distribution of a database, according to an example embodiment.

FIG. 2 is a flowchart illustrating a process for providing condensed representation of unique identifiers, according to an example embodiment.

FIGS. 3A-3D are example tables useful for illustrating a process for providing condensed representation of unique identifiers, according to some embodiments.

FIGS. 4A and 4B are example tables useful for illustrating the operation of a DDI (data and display identification) system when processing data, according to an example embodiment.

FIGS. 5A and 5B are example tables useful for illustrating additional operation of a DDI system, according to another example embodiment.

FIG. 6 is a block diagram of a system for providing condensed representation of unique identifiers, according to another example embodiment.

FIG. 7 is a flowchart illustrating another process for providing condensed representation of unique identifiers, according to an example embodiment.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

How data is displayed on a screen of a device for a user is often determined based on how much data is available (e.g., the quantity) or that needs to be displayed. Often, however, there are other factors that impact how to display data because displaying either too much or too little data could detract from the usefulness of the data. Such factors include the available screen size/space and the quality of the data that should be considered for display to provide the most useful data presentation via a user interface.

Accordingly, provided herein are system, apparatus, device, method and/or computer program product embodiments, and/or combinations and sub-combinations thereof, for providing condensed representation of identifiers on a user interface.

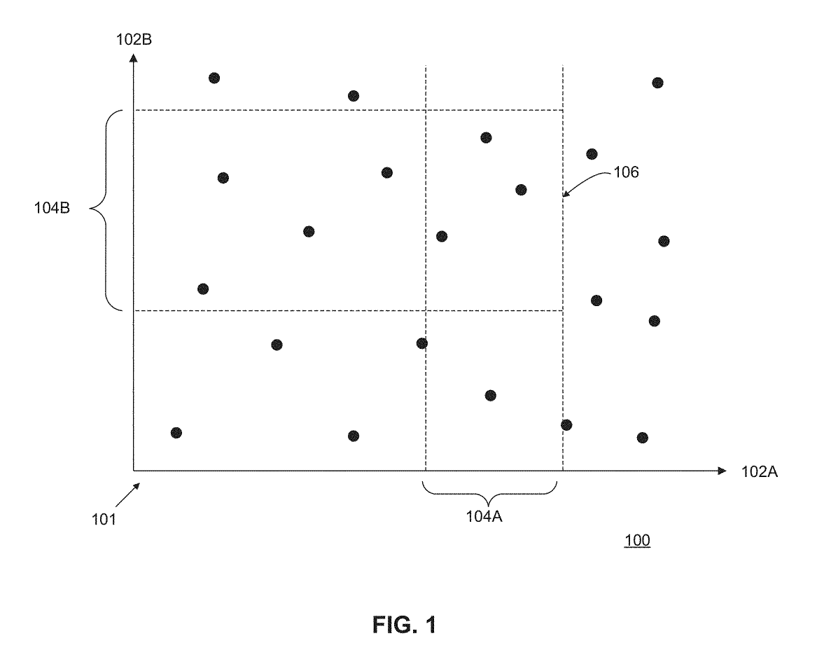

FIG. 1 is a block diagram of an example data distribution 100 of a database, according to an example embodiment. The different points in data set 101 may represent different records of a database. Dimensions 102A and 102B may indicate different dimensions, columns, or characteristics of the data of the database. As an example, an employee record may include the dimensions of name value, position or title, a salary, etc.

In the example shown, two filters 104A and 104B may be applied to the data of the database to identify a subset of the data that meets a particular criteria (e.g., as identified by filters 104). The result of the filters 104 being applied to the data set may be the resultant data set 106 which may be displayed on a screen. The data and display identification (DDI) system described herein provides a way to improve the user interface for displaying the resultant data set 106 on a user device.

As noted above, data set 101 may include different dimensions 102 or columns for different customer accounts of a particular company or organization. Examples include account number, first name, last name, address, account balance, age of account, etc. Different filters may be applied to identify a subset of the account holders that meet the filter criteria. For example, filter 104A may be those accounts located in the state of Florida, while filter 104B may be those accounts with balances greater than $1000. The result may be the subset of accounts shown in box 106, where the two filters 104 intersect, overlap, or where the data meets one or the other filter. Different embodiments, could include, more, less, or different filters.

A user interface may be configured to display the resultant subset 106 of data in a way that is meaningful to a user. This configuration may include determining which columns (e.g., dimensions) are both meaningful to a user and fit in an available screen space of the user interface of a particular device on which the data is to be displayed. As described in greater detail below, the same identified subset of data 106 may be displayed two different ways on two different devices with varying screen sizes or display area.

In some embodiments, rather than simply shortening the string length of identifiers, or replacing them with hash values, which may not be semantically meaningful to a user, the DDI system selects those data dimensions (e.g., columns or fields) that both fit within an available user interface and are semantically meaningful to a user (distinguishing field sets). For example, rather than displaying account number, last name, and state, which may be necessary to distinguish amongst the data of the entire data set 101 (which may include 1000 or more records), DDI system may configure a user interface to display the first name of the account holder which is all that is necessary to distinguish the three identified user accounts of the resultant set 106. In this example, each of the three account holders may have a unique first name and this may provide meaningful data to a user. The selection of the first name instead of the last name may be because the first name consumes less screen space than the last name, which may also be distinguishing and/or the first name may be determined to be more semantically meaningful to a particular user or group of users (than the last name of the account holders) who need to access the account data.

In another embodiment, a data space may include millions or even billions of records. To distinguish amongst that many records may require 30 columns (or more) of data values. However, if only 10 of those records are useful to a user or needed to displayed on a user interface, then DDI system may determine and balance the fewest number of columns/data that are to necessary to distinguish amongst the records with the semantic value of the data, such that the selected data fits within the designated or available screen space. In an embodiment, this may only require 1 or 2 columns of data. A distinguishing field set may include one or more fields that distinguish the records (to be displayed) from one another. As just described, the distinguishing field set may be configured to enhance the semantic weight and/or size weight of the various fields to identify the improved field set. In an embodiment, consuming less screen space may translate to having a higher size weight (e.g., more likely to be displayed).

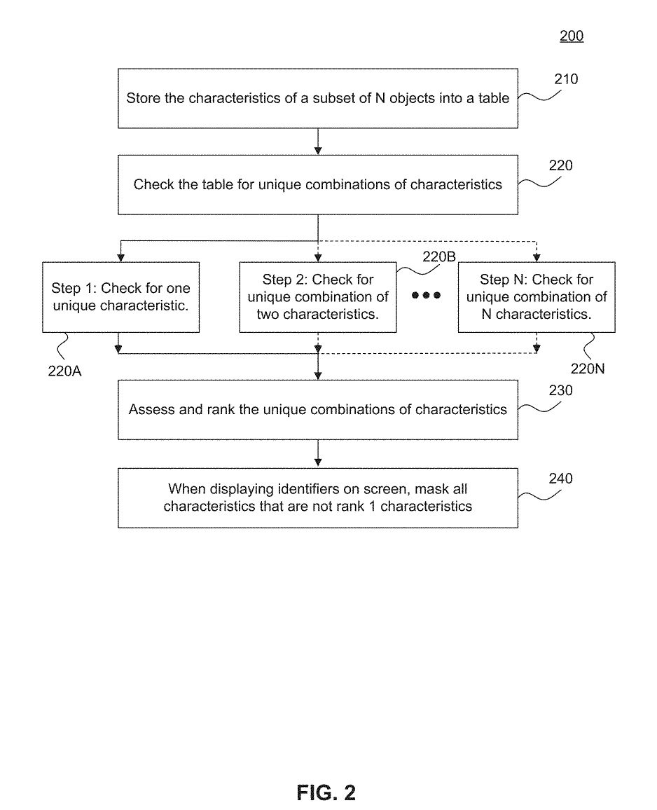

FIG. 2 is a flowchart illustrating a process 200 for providing condensed representation of unique identifiers, according to an example embodiment. FIG. 2 shows an example algorithm of how the data and display identification (DDI) system may process data to determine which identifiers for a subset of data to display on a user interface.

At 210, the characteristics of a subset of N objects may be stored into a table. For example, a subset 106 of data of a database 100 may be identified for display on a user interface; the subset 106 may be selected as being relevant to a user query or action. The characteristics or dimensions (e.g., column values in a row-oriented database or row values in a column-oriented database) of the subset may be stored in a table, or may otherwise be identified from the table(s) in which the data is already stored.

At 220, the table may be checked for unique combinations of characteristics. At 220A, the columns or fields of the subset 106 may be checked to determine if any single column of the subset would be sufficient to uniquely distinguish the records of the subset. For example, if the data includes account holders and the account holders have different last names, then the last name column may be a viable characteristic to display (e.g., distinguishing field set). However, if multiple account holders have the same last name, then the last name characteristic or dimension may not be enough to distinguish the subset of data. The first name column may then be checked. If one or more single columns or characteristics of data are identified as being unique amongst the account holders, then the DDI system may continue to 230.

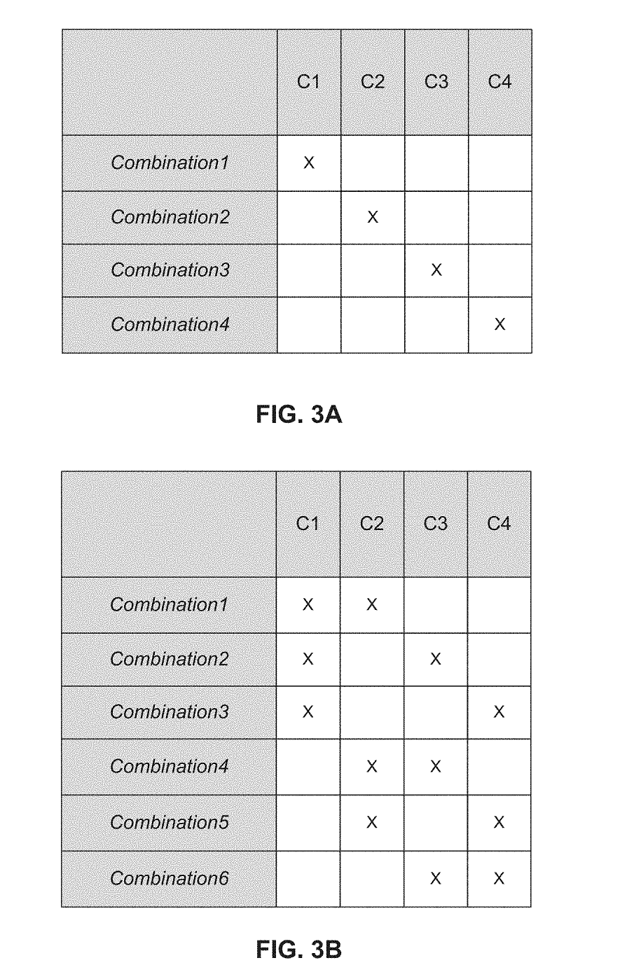

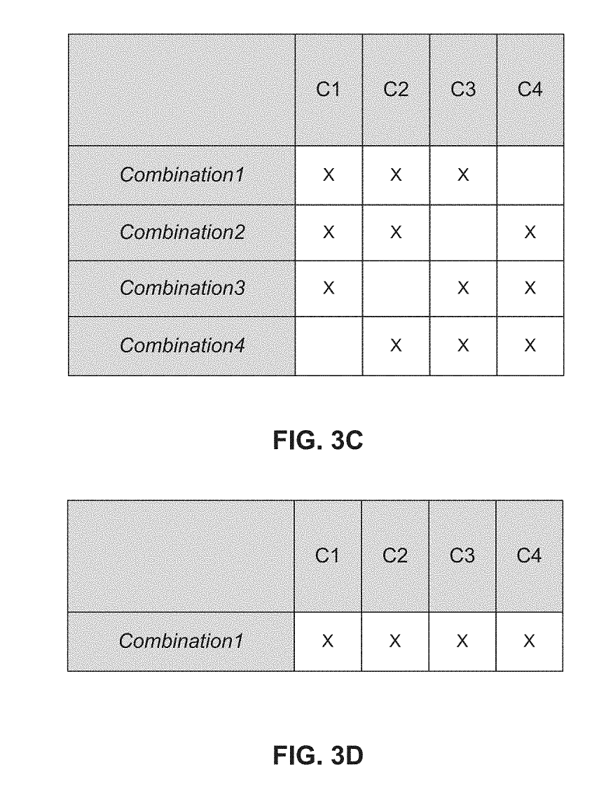

If however, a single column is not enough (e.g., if multiple account holders have similar first names and last names), then processing may continue to 220B. At 220B, different two-column combinations may be tested (e.g., first name and last name). If the DDI system determines that there are one or more two-column combinations, then the system may continue to step 230. Otherwise, the DDI system may continue to step 220N and check three column combinations, and so forth, until all column combinations are checked or a unique combination of columns is determined to distinguish amongst the subset. This process is shown in greater detail in FIGS. 3A-3D.

FIGS. 3A-3D are example tables useful for illustrating a process for providing condensed representation of unique identifiers, according to some embodiments. As shown in FIG. 3A, the first column C1 is checked to determine if it comprises a unique combination of values for the data set. This process is then repeated for the remaining columns C2, C3, and C4. As described with respect to block 220, if one or more of columns 1-4 are determined to be unique, then the process may exit and continue to block 230.

If however, no single column is unique amongst the data set to be displayed (e.g., resultant set), then different two-column combinations may be tried as shown in FIG. 3B. The combinations as show are C1-C2, C1-C3, C1-4, C2-C3, C2-C4, and C3-C4. If no unique combinations are found, three column combinations of FIG. 3C are tried, and then finally the four column combination of FIG. 3D. Other embodiments may use more or less than four column combinations.

Returning to FIG. 2, at block 230 if multiple column combinations (e.g., multiple single columns are distinguishing, or multiple multi-column combinations) are identified as being distinguishing amongst the data of the resultant set 106, the various combinations may be evaluated and ranked to determine which is the optimized or otherwise improved combination. For example, if either column C2 or C3 may be used to distinguish amongst the data of the data asset, then at 230, DDI system may determine whether to use column 2 or 3. The same may be true if multiple multi-column combinations are found to be distinguishing.

In an embodiment, different characteristics or columns may be assessed, sorted, or ranked using different criteria. The criteria may include, for example, the size or length of the data (e.g., relative to the screen size, screen threshold, or available display area), and the semantic value of the different columns. In an embodiment, different columns may be ranked or weighted with different semantic weights (e.g., relative a user). The more meaningful or semantically relevant a column value, the higher its rank or weight. For example, the first or last name of an account holder may be more meaningful than an internal reference number. Or, for another user (e.g., with a different role), the account number or reference number may be more meaningful than the names.

However, amongst first and last names, first name may require less display area on a user interface (e.g., have a greater size weight) and may be ranked higher than last name in a particular example. Weighing the different criteria, DDI system may determine which column(s) of data to display and how to configure the user interface, allowing the user interface to display semantically meaningful data to a particular user that may have otherwise not been able to be displayed (e.g., on a particular screen size of a user device).

Provided below is an example of how weights may be defined for different columns of a data provider object, “Contacts.” In the example provided below, the data type for USER_ID (which may be the name of a column or dimension) is character of length 10, however in other embodiments different data types may be used, and the length of the data may be determined statically or dynamically. Also, although the different columns below are shown with different semantic weights, in other embodiments, the semantic weight for one or more columns (or selected columns) may be the same, effectively disabling the effect of semantic weights. In such embodiments, since semantic weight is the same across the columns, length (i.e., size weight) may take on greater importance or be used to determine or select which columns to use to differentiate amongst the data.

```
DataProvider = new DataProvider( label = ‘Contacts’).
DataProvider->addColumn(
        id = ‘USER_ID’
        type = ‘char(10)’
        semanticWeight = 1 ).
DataProvider->addColumn(
        id = ‘NAME’
        type = ‘char(60)’
        semanticWeight = 10 ).
DataProvider->addColumn(
        id = ‘Street’
        type = ‘char(60)’
        semanticWeight = 5 ).
DataProvider->addColumn(
        id = ‘City’
        type = ‘char(30)’
        semanticWeight = 4 ).
```

An example result set of data may include 3 results or records as provided below (other embodiments may have more or less than 3 results of records). The DDI may determine, based on which and how many records are part of the result set, how to enhance or configure a user interface used to display the result set. This configuring of the user interface may include determining or identifying the one or more distinguishing field sets (i.e., identifying column(s) of the result set) to display for the result set and evaluating their weights.

TABLE 1
Shows an example result set

| INDEX | USER_ID | NAME | STREET | CITY |
|---|---|---|---|---|
| 1 | 14 | Peter | Heilbronner Str. 37 | Neckarsulm |
| | | Mustermann | | |
| 2 | 35 | Some other guy | Walter-Koch-Str. 1 | Sinsheim |
| 3 | 98 | Some other girl | Stuttgarter Straße 17 | Munchen |

Note that in the example provided, every column has unique values so all three column or dimensions could be identifiers (e.g., distinguishing field sets). However in the example provided, column NAME may be selected as the field to be displayed in the user interface because USER_ID, Street and City all have a lower semantic weights. If there is additional screen space, additional information (e.g., fields) not necessary to distinguish amongst the records may also be provided based on their semantic or size weight.

In an embodiment, the ranking or weighing of columns may be used prior to the column evaluation in block 220, or even prior to the identification of which columns to evaluate in block 210. For example, the DDI system may only select those columns for evaluation that meet or exceed a threshold for semantic value or display space/size weight (e.g., data with large values may be excluded from evaluation for devices with small screen sizes). Or semantically insignificant data may not be evaluated.

In using the weights, the columns may be sorted or pre-sorted in ascending or descending order according to their weights, prior to executing the blocks of FIG. 2. Then the DDI may execute the algorithm. At 220, when the DDI identifies the first identifier (with the greatest weight), no additional identifiers are tested. The first found solution would automatically be the one with the highest ranking.

This approach or determining when to rank, weight, or sort the fields or columns may speed up processing and display capabilities of a system, and may be implemented regardless of the size or dimensions of a user interface. For example, pre-sorting may reduce the number of fields that are evaluated as distinguishing field sets. As such, there may be a sorting step performed prior to 210. However, such sorting is optional.

In step 220A (as shown in the top row of FIG. 3A), the most semantically valuable column (that fits in the available display area) may be evaluated first. If the column is distinguishable amongst the data set, no other columns may need to be evaluated or processed. This process may be implemented for multiple column-sets as well (e.g., as shown in FIGS. 3B and 3C), as the two most semantically valuable columns may be evaluated first and so on as described in steps 220B-N.

In another embodiment, the ranking or weighting may be performed after the identification of unique combination(s) of characteristics as shown in step 230. In this example, the DDI may determine which combination(s) of identifiers fit on the screen (based on the size of the values and the size or dimensions of the user interface) and which are ranked highest according to semantic weights. The DDI may first evaluate identifiers regarding size and then rank/sort the resulting set of qualified identifiers by semantic weight. An example of this is shown below.

TABLE 2
Shows possible combinations

| INDEX | COLUMNS | Semantic_weight | Length |
|---|---|---|---|
| 0 | ID | 1 | 10 |
| 1 | ID, Name | 1 + 10 = 11 | 10 + 60 = 70 |
| 2 | ID, Street | 1 + 4 = 5 | 10 + 60 = 70 |
| 3 | ID, City | 1 + 5 = 6 | 10 + 30 = 40 |
| 4 | Name, Street | 5 + 10 = 15 | 60 + 60 = 120 |
| 5 | Name, City | 4 + 10 = 14 | 60 + 30 = 90 |
| 6 | Name, Street, City | 4 + 5 + 10 = 19 | 60 + 60 + 30 = 150 |
| 7 | ID, Name, Street, | 1 + 4 + 5 + 10 = 20 | 10 + 30 + 30 + 60 = |
| | City | | 160 |
| . . . | . . . | | |

As an example, in an embodiment, a desktop or laptop computer may have a maximum length or size of identifier of 130 characters. As such, using ID as an identifier might not be useful or practical, based for example on its length and semantic weight. On the screen of 130 characters, there may be enough room for additional, more semantically relevant information, other than just ID. The second and third identifiers are of similar rank, but Name+City results in a shorter string. Of these two, the DDI may select Name+Street (length 120) due to its shorter length. In another embodiment however, the DDI may alternatively select the combination with the higher weight that still fits in the display area.

On a smartphone or mobile device with a smaller display screen or user interface, there may be a fixed screen size of 95 characters, as an example. In this scenario, the DDI may select Name+City (length 90) because Name+Street (length 120) may not fit on the screen. Other identifiers or combinations, which may have a greater semantic weight, but are too long, may not be displayed on either device (the computer or the mobile device).

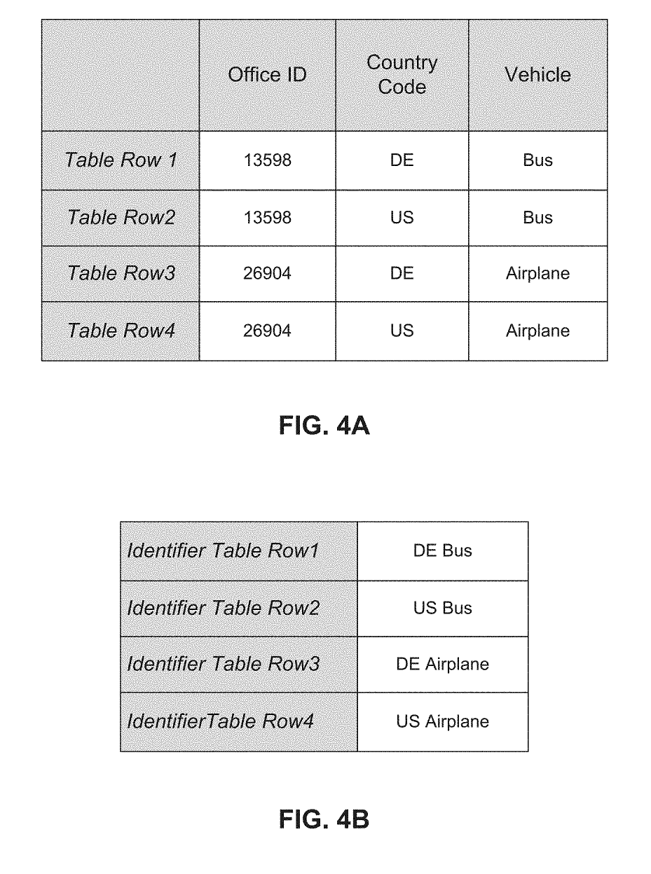

FIGS. 4A and 4B are example tables useful for illustrating the operation of a DDI (data and display identification) system when processing data, according to an example embodiment. In FIG. 4A, in the resultant data set to be displayed, no single column by itself may be unique enough to be displayed. However, there are two possible two-column data sets that would distinguishable amongst the data: “Office ID”∥“Country Code” and “Country Code”∥“Vehicle.”

In an embodiment, the columns may all fit into the display screen, and be ranked according to their semantic value. For example, vehicle may have rank of 1 (e.g., being the most semantically valuable), country code may have a rank of 2, and office ID may have a rank of 3.

As shown in FIG. 4B, in an embodiment, DDI system may rank the two two-column possibilities based on their semantic weights, determining that country code and vehicle are more semantically valuable than office ID and country code. In another embodiment, country code and vehicle may be analyzed prior to office ID and country code, and upon a determination that country code and vehicle is distinguishable, office ID and country code may not need to be evaluated.

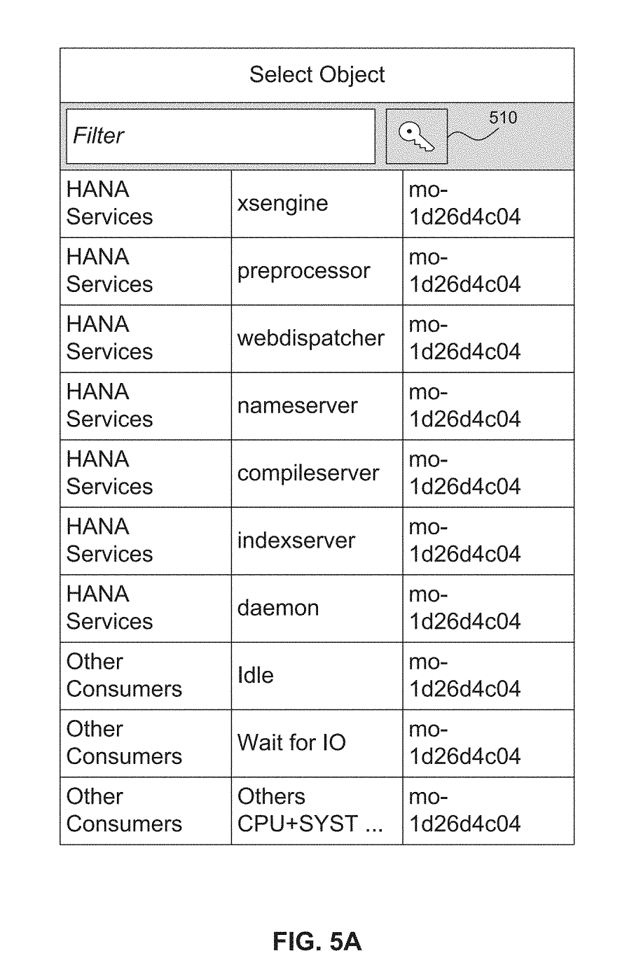

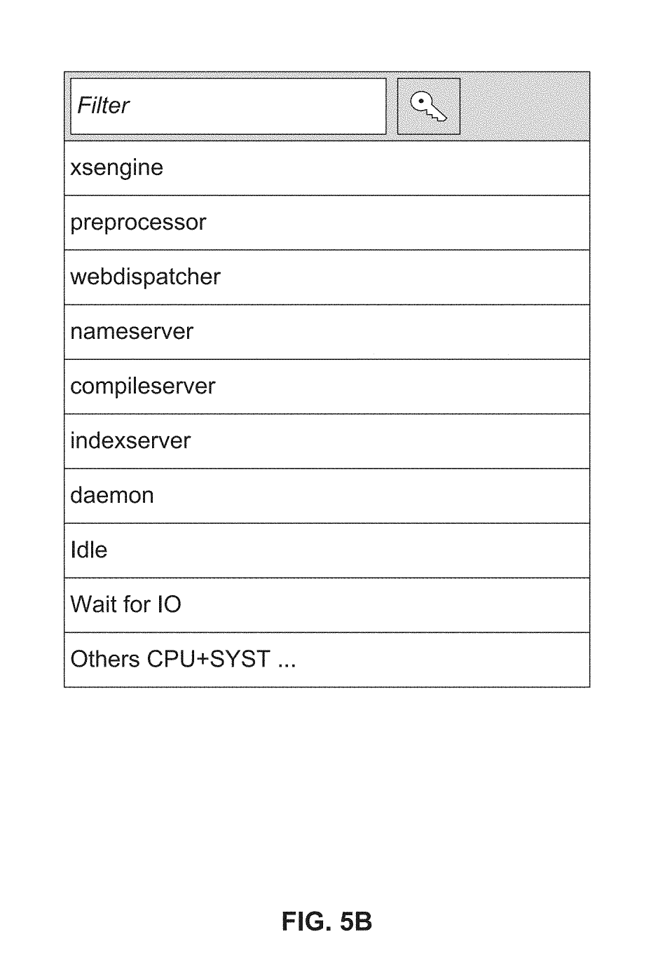

FIGS. 5A and 5B are example tables useful for illustrating additional operation of a DDI system, according to another example embodiment. In FIG. 5A three columns of data may exist for a data subset to be displayed. In an embodiment, a user may select the key icon 510 and the DDI system may generate the configured or optimized data shown in FIG. 5B. In the example shown, the middle column of data may be unique and may be the only one that is displayed, as it has both semantic value and fits on the display screen. In another embodiment, the table or display may, by default or automatically, process the data and select the most optimized display without user interaction.

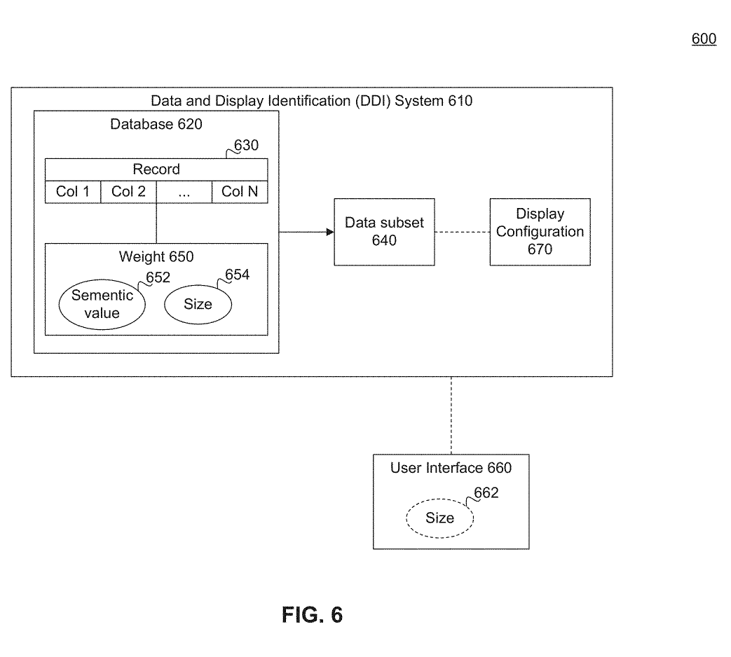

FIG. 6 is a block diagram of a system 600 for providing condensed representation of unique identifiers, according to another example embodiment. FIG. 6 includes an example data and display identification (DDI) system 610. In the example, a database 620 may include records 630. Records 630 may have columns which may be weighted (650). In an embodiment, a particular data set (set of records 630) may include its own unique set of columns (or may share a column with other data sets) with its own different or unique weights (650).

In different embodiments, different weights may be used, such as semantic value 652 and size or length 654. The relative value or weight of semantic value 652 and length 654 may vary in different embodiments. Only a subset 640 of the data of the database 620 may need to be displayed on a user interface 660. The user interface 660 may be of a particular size 662 (which may vary across different devices, e.g., cell phones, laptops, televisions, etc.). Taking into account the size 662 and the weight 650, DDI 610 may determine a display configuration 670. The display configuration 670 may display the minimum amount of data that is semantically valuable to the user via a configured user interface 660 of a particular size 662. As such, different devices with different interface sizes 662 may display data from the same data set differently (e.g., particularly if size 654 is valued more than semantic value 652).

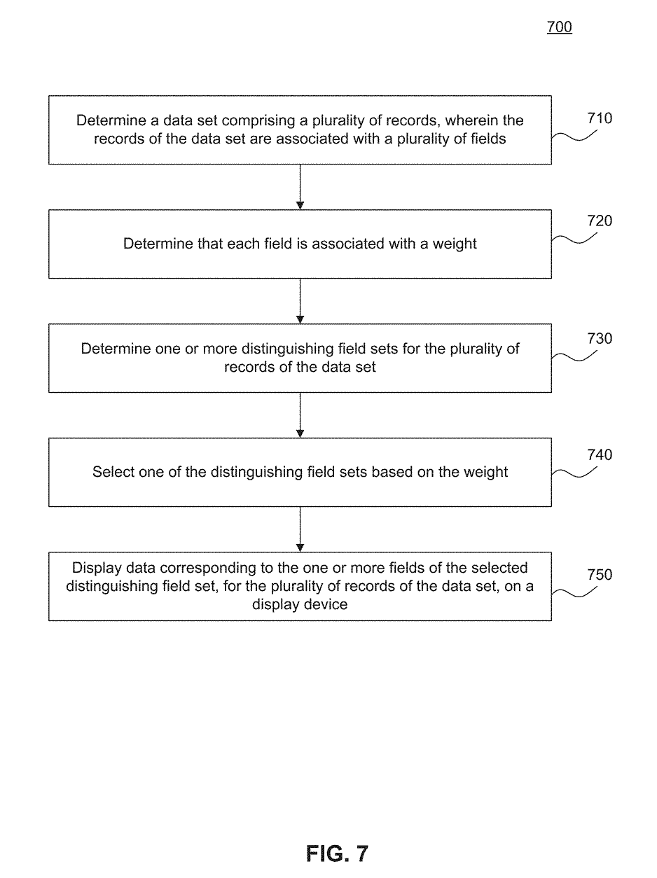

FIG. 7 is a flowchart illustrating another process for providing condensed representation of unique identifiers, according to an example embodiment. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

At 710, a data set including a plurality of records is determined, wherein the records of the data set are associated with a plurality of fields. For example, as shown in FIG. 1, a resultant data set 106 for the plurality of records of a larger data set 101 may be determined. Filters 104A and 104B may be applied to the data set 101 to determine the resultant set 106.

At 720, it is determined that each field is associated with a weight. For example, as shown in FIG. 6, different fields or columns may each be associated with a weight 650. Weight 650 may include a semantic weight 652 and/or a size weight 654.

At 730, one or more distinguishing field sets are determined for the plurality of records of the data set. For example, as shown in FIGS. 3A-3D, different combinations of fields may be analyzed to determine which field or field combinations are distinguishing amongst the records.

At 740, one of the distinguishing field sets is selected based on the weight. For example, as shown in FIG. 4A, different field combinations may be used as distinguishing field sets. Office ID may be a distinguishing field, or a combination of country code with vehicle may be a distinguishing field set. Based on the semantic weights, the combination of country code and vehicle may be selected as the distinguishing field set over Office ID.

At 750, data corresponding to the one or more fields of the selected distinguishing field set is displayed, for the plurality of records of the data set, on a display device. For example, as shown in FIG. 6. DDI 610 may arrange a display configuration 670 for the data subset 640, for the user interface 660. In an embodiment, DDI 610 may take into account the size 662 of the user interface in determining display configuration 670.

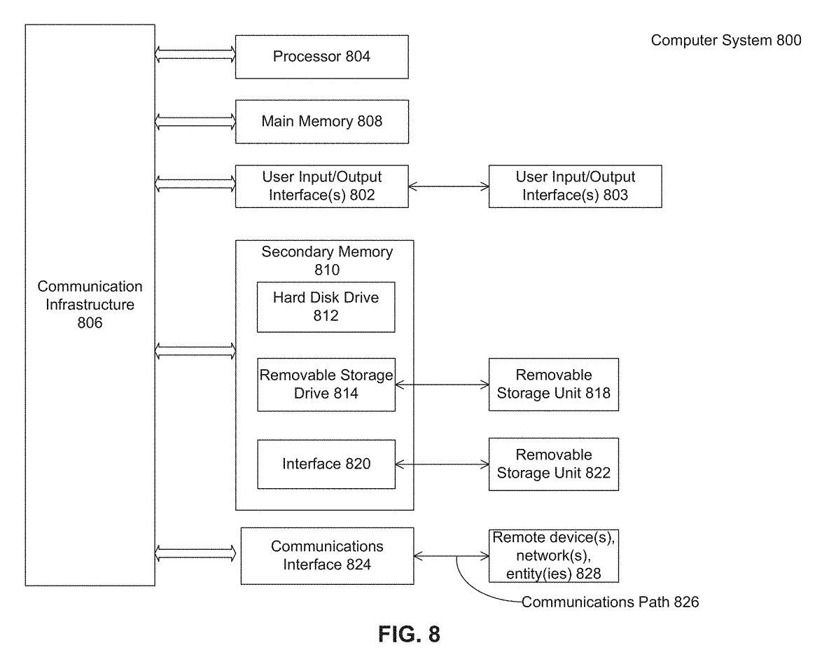

Various embodiments can be implemented, for example, using one or more well-known computer systems, such as computer system 800 shown in FIG. 8. Computer system 800 can be any well-known computer capable of performing the functions described herein.

Computer system 800 includes one or more processors (also called central processing units, or CPUs), such as a processor 804. Processor 804 is connected to a communication infrastructure or bus 806.

One or more processors 804 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 also includes user input/output device(s) 803, such as monitors, keyboards, pointing devices, etc., that communicate with communication infrastructure 806 through user input/output interface(s) 802.

Computer system 800 also includes a main or primary memory 808, such as random access memory (RAM). Main memory 808 may include one or more levels of cache. Main memory 808 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to an exemplary embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible apparatus or article of manufacture comprising a tangible computer useable or readable medium having control logic (software) stored thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
determining a data set comprising a plurality of records, wherein the records of the data set are associated with a plurality of fields;
determining that each field is associated with a weight, wherein the weight comprises one or more of a semantic weight and a size weight;
determining one or more distinguishing field sets for the plurality of records of the data set, wherein each distinguishing field set comprises one or more of the fields that distinguish the records from one another;
selecting one of the distinguishing field sets based on the weight; and
displaying data corresponding to the one or more fields of the selected distinguishing field set for the plurality of records of the data set on a display device.

2. The method of claim 1, wherein the selecting comprises:
determining the semantic weight of the one or more distinguishing field sets;
determining a subset of the distinguishing field sets that exceed a semantic threshold; and
selecting one of the subset of the distinguishing field sets that exceed a semantic threshold.

3. The method of claim 2, wherein the determining that each field is associated with the weight comprises:
determining the size weight for those distinguishing field sets that exceed the semantic threshold, wherein one or more of the determined distinguishing field sets that do not exceed the semantic threshold are not evaluated for the size weight.

4. The method of claim 1, wherein the determining that each field is associated with the weight comprises:
determining a size threshold of the display device;
determining a subset of the plurality of fields are within the size threshold, wherein at least one or more of the fields exceed the size threshold; and
wherein the determining the one or more distinguishing field sets comprises selecting one or more fields for each distinguishing field set from only the subset of the plurality of fields that are within the size threshold.

5. The method of claim 4, wherein the selecting comprises:
determining a semantic weight for each determined one or more distinguishing field sets; and
selecting one of the distinguishing field sets with a highest semantic weight.

6. The method of claim 5, wherein the selecting one of the distinguishing field sets with the highest semantic weight comprises:
determining that two of the distinguishing field sets have a same highest semantic weight;
determining a size weight of each of the two distinguishing field sets, wherein a field set with a smaller size has a higher weight; and
selecting one of the two distinguishing field sets with a highest size weight.

7. The method of claim 1, wherein the determining the weight comprises:
determining an individual semantic weight for the plurality of fields;
sorting the plurality of fields by their individual semantic weight; and
determining one or more of the plurality of fields comprises a distinguishable field set with a highest semantic weight, wherein one or more combinations of fields with lower semantic weights are not evaluated.

8. A system, comprising:
a memory; and
at least one processor coupled to the memory and configured to:
determine a data set comprising a plurality of records, wherein the records of the data set are associated with a plurality of fields;
determine that each field is associated with a weight, wherein the weight comprises one or more of a semantic weight and a size weight;
determine one or more distinguishing field sets for the plurality of records of the data set, wherein each distinguishing field set comprises one or more of the fields that distinguish the records from one another;
select one of the distinguishing field sets based on the weight; and
display data corresponding to the one or more fields of the selected distinguishing field set for the plurality of records of the data set on a display device.

9. The system of claim 8, wherein, to select, the processor is configured to:
determine the semantic weight of the one or more distinguishing field sets;
determine a subset of the distinguishing field sets that exceed a semantic threshold; and
select one of the subset of distinguishing field sets that exceed the semantic threshold.

10. The system of claim 9, wherein, to determine that each field is associated with the weight, the processor is configured to:
determine the size weight for those distinguishing field sets that exceed the semantic threshold, wherein one or more of the determined distinguishing field sets that do not exceed the semantic threshold are not evaluated for the size weight.

11. The system of claim 8, wherein, to determine that each field is associated with the weight, the processor is configured to:
determine a size threshold of the display device;
determine a subset of the plurality of fields are within the size threshold, wherein at least one or more of the fields exceed the size threshold; and
wherein the processor to determine the one or more distinguishing field sets is configured to select one or more fields for each distinguishing field set from only the subset of the plurality of fields that are within the size threshold.

12. The system of claim 11, wherein, to select, the processor is configured to:
determine a semantic weight for each determined one or more distinguishing field sets; and
select one of the distinguishing field sets with a highest semantic weight.

13. The system of claim 12, wherein, to select one of the distinguishing field sets with the highest semantic weight, the processor is configured to:
determine that two of the distinguishing field sets have a same highest semantic weight;
determine a size weight of each of the two distinguishing field sets, wherein a field set with a smaller size has a higher weight; and
select one of the two distinguishing field sets with a highest size weight.

14. The system of claim 8, wherein, to determine the weight, the processor is configured to:
determine an individual semantic weight for the plurality of fields;
sort the plurality of fields by their individual semantic weight; and
determine one or more of the plurality of fields comprises a distinguishable field set with a highest semantic weight, wherein one or more combinations of fields with lower semantic weights are not evaluated.

15. A non-transitory computer-readable device having instructions stored thereon that, when executed by at least one computing device, causes the at least one computing device to perform operations comprising:
determining a data set comprising a plurality of records, wherein the records of the data set are associated with a plurality of fields;
determining that each field is associated with a weight, wherein the weight comprises one or more of a semantic weight and a size weight;
determining one or more distinguishing field sets for the plurality of records of the data set, wherein each distinguishing field set comprises one or more of the fields that distinguish the records from one another;
selecting one of the distinguishing field sets based on the weight; and
displaying data corresponding to the one or more fields of the selected distinguishing field set for the plurality of records of the data set on a display device.

16. The device of claim 15, wherein the selecting comprises:
determining the semantic weight of the one or more distinguishing field sets;
determining a subset of the distinguishing field sets that exceed a semantic threshold; and
selecting one of the subset of distinguishing field sets that exceed the semantic threshold.

17. The device of claim 16, wherein the determining that each field is associated with the weight comprises:
determining the size weight for those distinguishing field sets that exceed the semantic threshold, wherein one or more of the determined distinguishing field sets that do not exceed the semantic threshold are not evaluated for the size weight.

18. The device of claim 15, wherein the determining that each field is associated with the weight comprises:
determining a size threshold of the display device;
determining a subset of the plurality of fields are within the size threshold, wherein at least one or more of the fields exceed the size threshold; and
wherein the determining the one or more distinguishing field sets comprises selecting one or more fields for each distinguishing field set from only the subset of the plurality of fields that are within the size threshold.

19. The device of claim 18, wherein the selecting comprises:
determining a semantic weight for each determined one or more distinguishing field sets; and
selecting one of the distinguishing field sets with a highest semantic weight.

20. The device of claim 19, wherein the selecting one of the distinguishing field sets with the highest semantic weight comprises:
determining that two of the distinguishing field sets have a same highest semantic weight;
determining a size weight of each of the two distinguishing field sets, wherein a field set with a smaller size has a higher weight; and
selecting one of the two distinguishing field sets with a highest size weight.
